(19) United States
(12) Patent Application Publication
(10) Pub. No.: US 2014/0156321 A1
(43) Pub. Date: Jun. 5, 2014

(54) METHOD AND SYSTEM FOR FACILITATING RESERVATIONS, RENTAL AND/OR PURCHASE OF SERVICES/GOODS WITHOUT CREDIT CARDS

(71) Applicant: ZARR HOLDINGS, LLC, Delray Beach, FL (US)

(72) Inventors: David Coury, Delray Beach, FL (US); Nicholaos Rokanas, Delray Beach, FL (US); Ron Dable, Delray Beach, FL (US); James L. Schalberg, Rock Hill, SC (US)

(73) Assignee: ZARR HOLDINGS, LLC, Delray Beach, FL (US)

(21) Appl. No.: 14/095,935

(22) Filed: Dec. 3, 2013

Related U.S. Application Data
(60) Provisional application No. 61/732,662, filed on Dec. 3, 2012.

(51) Int. Cl. G06Q 10/02; G06Q 30/06

(52) U.S. Cl. CPC G06Q 10/02; G06Q 30/0645
USPC 705/5

(57) ABSTRACT

A method for providing credit-card-free access to an end-user who is renting an item from a provider, which involves registering an end-user with a trusted third party via a trusted-third-party server using an end-user portal; registering a provider with the trusted third party via the trusted-third-party server using a provider portal; and providing the end user with a transaction element usable in connection with said trusted-third-party server, the transaction element configured to provide to the provider, via the trusted-third-party server: verification of the identity the end user; verification of funds available to rent an item for the provider; and a transaction fraud check to confirm, at the time of a transaction, that the end-user is authorized to conduct the transaction.

### CROSS-REFERENCE TO RELATED APPLICATIONS

This application is based on, and claims priority to, U.S. Provisional Application No. 61/732,662, filed Dec. 3, 2012, the entire contents of which being fully incorporated herein by reference.

### BACKGROUND OF THE INVENTION

The present invention relates to a method and system for facilitating reservations for rental items and/or purchases of items and/or services, and more particularly to the facilitation of reservations for and rental/purchase of items/service by individuals who do not have credit cards or similar payment options available to them, from rental companies and/or sales agents who will not rent/sell to consumers unless the consumer has a credit card or other form of non-cash payment options. In a preferred embodiment described herein, the invention is described in connection with the rental of cars or other vehicles by a rental car customer; it is understood, however, that this description is given for the purpose of example only and the invention is not limited to use with rental companies.

By way of summary, the method and system of the invention provides at least the following:
It provides a system to deliver qualified renters to approved affiliates by bridging the gap between a credit card rental and a debit card or cash rental.
It bridges the gap between credit cards and other forms of payment by providing the rental operator (or other service/goods provider) with the same protections afforded by a credit card, and as a result, persons who do not have credit cards can still make reservations with and/or purchases from entities that otherwise require that the renter/purchaser have a credit card available for use;
It allows debit card or cash clients to now become eligible for the industry standards to rent cars
It provides a guarantee of payment similar to the manner in which a credit card can be used to guarantee payment;
It provides at least a minimum level of fraud protection for the entity renting/selling to a user who does not possess a credit card;
In the context of renting of vehicles and other high ticket items subject to damage during the rental, it provides primary insurance on the item and user, including collision insurance for vehicles, during each rental;
It provides verified age, address, and information regarding general and credit-based stability of the user who does not possess a credit card;
It allows a user to preload funds onto a membership/loyalty card to be used in connection with a participating entity;
It allows a user to be pre-qualified to rent an item (e.g., a car) based on the latest industry standards for such rentals;
It will assure a participating entity that the user owning the membership/loyalty card has a minimum balance (e.g., $75.00) on the card for incidentals (e.g.: parking tickets, tolls, minor damage, fuel);
It provides a central location, via a website, for users to manage their account/funds and for participating entities to manage their accounts/funds;
It provides a reservation portal directly to the participating entity.

The invention is sometimes referred to herein as the “ZARR Card” or “ZARR Card Rental” for the sake of simplicity, as the term “ZARR” and ZARR Card” are intended to be used in connection with the invention as trademarks; it is understood that this term is completely arbitrary and is used to identify the invention broadly.

In the rental car industry, the standard practice is to only allow vehicles to be reserved and rented if the customer who wants to rent the car has a credit card, such as those issued by American Express, MasterCard, Visa, Discover, etc. The belief is that persons who possess such cards are better credit risks and may be more responsible. Further, having the credit card on file allows the car rental company to charge additional fees to the card for fuel, certain damages, late vehicle return, and the like. The credit card allows the car rental company to obtain an almost instant credit check of the customer, since the card-issuer approves the use of the card when the transaction is being processed. In addition, many credit card issuers also provide insurance protection when renting a vehicle.

From the perspective of the car rental company, using the credit card as a means to check credit, guarantee payment, and have the vehicle insured gives them a way to quickly process the incoming customer, in a business where speed is critical. Long lines in the rental car company office or at a rental car company desk in an airport might cause potential customers to move on to another companies office or desk, thereby losing potential income for the rental car company. As a result, the standard practice is for the rental car company to only take reservations and rent cars to people with credit cards.

Some people don't like using credit cards and thus do not possess credit cards; other people may be young and/or without sufficient credit history to obtain a credit card. In each of these cases, the persons without credit cards may have access to sufficient cash to enable them to rent the car, but because they do not have a credit card, they cannot. A potential customer carrying a bag full of cash will be turned away, as will a potential customer with a debit card that provides instant access to sufficient cash. While adopting this “no credit card-no rental” policy keeps the lines moving, the car rental company is likely losing business that it could otherwise be capturing.

In view of the above, it is clear that here is a need for a method/system to enable reservations to be made for rental or purchase of items/services, and/or to enable the actual rental or purchases of items/services, by individuals who do not have credit cards or similar payment options available to them, from rental companies and/or sales agents who will not rent/sell to consumers unless the consumer has a credit card or other form of non-cash payment options. The present invention provides a method and system for meeting this need.

ZARR Card Rental endeavors to become the premier car rental membership program by providing a qualified pool of renters that were previously prevented from short term vehicle rentals by traditional industry policies.

Current practices disallow rentals to persons who do not have a major credit card or prefer to pay via debit card or cash. Ironically, the industry allows payment on return of the vehicle by these methods.

Not only does the ZARR Card Membership grant a vetted and qualified group of individuals access to car rentals, it also acts as a pre-qualifier for car rental companies.

The Membership is expected to provide a growth opportunity of 20% for the car rental market and will be available to both major auto rental companies as well as independent rental businesses.

The ZARR Card is expected to become a major force in the auto rental industry by facilitating transactions between a previously unexploited target market and car rental operators.

Problem: Rental companies tend decline people without a major credit card due to the belief that ownership of the card constitutes a lower risk and provides an element of security to charge additional fees after the rental period. The credit card offers an instant credit check due to the approval process from the issuing bank, many of whom provide insurance collision protection for both the renter and rental operator.

Customers: The market size consists of:
Approximately 82.6 million licensed drivers without a vehicle in 2010
183 million Debit Card Holders
   Debit card usage is expected to grow in the next 5 years by an average of 24.6% per year to reach $9.2 billion by 2017
17,758 Auto Rental Locations with estimated revenue of $22.4 billion per year.
   One third of the industry is owned by independent businesses
   21% of this market will be addressed in the first 5 years

Competition: Established car rental companies are not addressing this market segment because there is no known competitive alternative. Additional procedures necessary to ensure the renter qualifies to rent the vehicle takes time, thus, major car rental companies opt to decline the rental and concentrate on faster and easier transactions. ZARR Card Membership will eliminate the need for any additional procedures.

Regulatory: Federal regulations require funds accumulated under this program to be held in escrow to ensure balances are available for rentals and membership obligations. There will always be a minimum balance held on the card and be available for any parking or toll violations that may arise after the conclusion of the rental. This assures auto rental locations that funds will be available to pay for the rental and cover any additional costs.

### SUMMARY OF THE INVENTION

A method for providing credit-card-free access to an end-user who is renting an item from a provider is provided, comprising: registering an end-user with a trusted third party via a trusted-third-party server using an end-user portal; registering a provider with the trusted third party via the trusted-third-party server using a provider portal; and providing the end user with a transaction element usable in connection with said trusted-third-party server, said transaction element configured to provide to the provider, via the trusted-third-party server: verification of the identity the end user; verification of funds available to rent an item for the provider; and a transaction fraud check to confirm, at the time of a transaction, that the end-user is authorized to conduct the transaction.

The method also provides the registration of the end-user with the trusted third party by which the end user completes an application for forwarding to a verification company, the verification company using the completed application to conduct an initial fraud check on the end-user and providing results of said initial fraud check to said trusted-third-party server, where it is stored.

The method further provides trusted-third-party management of insurance to the end user by establishing a relationship with an insurance provider, which insurance provider provides insurance to the end user.

The method also provides accessibility to the end-user portal via an end-user device capable of connecting to the trusted-third-party server.

The method also provides accessibility to end-user portal via a device provided at a location of the provider.

The method further comprises providing an authorized end-user access to an authorized end-user portal providing the end-user with account management capability so that the end-user can manage account information stored on said trusted-third-party server.

The method further provides for the item to be rented to be a rental vehicle.

The method also includes the provider comprising a vehicle-rental company.

The Offering: The membership program will create a secure payment transaction and will ensure:
a. Reservations can be made via the Company's secure internet website
b. Funds are held in escrow to satisfy rental obligations
c. Accessibility via the Company's secure internet website
d. Qualified renters are identified and verified through the ZARR Card screening process
e. Instant validation takes place at point of sale with the swipe of a card
f. Collision and Comprehensive insurance becomes effective on commencement of the rental.

The membership card will enable auto rental companies to provide insured vehicle rentals to clients who were previously declined due to a need for additional verification steps.

Value Proposition: The program solves the problem of customers that do not want to use a credit card to rent a vehicle or do not have a credit card. It also solves the issue of collision insurance on rental vehicles and payment for rentals. These features jointly open up the larger market of rapidly expanding debit card and non-credit card holders. The ZARR Card website allows for online payments so members can add necessary funds for their next rental and also make reservations.

Additional dollars may be added to the account at the rental location by cash, check or debit card for immediate or urgent rentals. Contributions can be made to the balance either on a “pay as you go” basis or on a “subscription plan” where a pre-determined amount can be transferred from the member's bank account on a regular basis. Dealers will pay a fee for each car rental as this is incremental business that was previously lost.

Competitive Advantage: ZARR Card's direct competitors are credit card companies like American Express, Visa, Master Card and Discover. They provide the renter with instant credit worthiness at the point of sale and many of them provide car rental protection in a various array of coverages.

The first of many advantages ZARR has over credit card companies is the ability to conduct an instant fraud check and renter qualification at point of sale for any potential member in less than one minute. No other program exists that can instantly qualify a rental prospect.

Customer Validation: Auto rental companies (also referred to as “Affiliate” or “Affiliates” herein) have approached to determine their willingness to accept debit cards or cash and all have declined vehicle rentals if no credit card is presented.

Development Status: The ZARR website will accommodate programs necessary for the initial sign up of new members. On the rental company side, the rental agent will be able to initialize the transaction and re-qualify the renter. Membership card record keeping technology already exists and can be linked to the website.

Affiliate Locations: Affiliate rental locations will execute an affiliate agreement with ZARR and once authorized will have access to the rental side of the website. The affiliate will have the ability to sign up new members at point of sale as well as offer memberships to their regular clientele.

Distribution: Membership in the program will be achieved via several means:
1. Sign up the affiliate locations
2. Marketing campaigns in the geographical area of new affiliates on a cost sharing basis.
3. Point of sale at existing affiliates.
4. Internet sales on the ZARR Card Website.
5. Display & media advertising including radio, TV, email, social media and mobile marketing.

Revenue Streams

The Company anticipates generating revenue through multiple streams including members, dealers, and payment processing companies.

Traditionally the car rental industry as a whole prefers to rent to customers that have a credit card as they provide:
An instant SSN check
A guarantee of payment
A modicum of fraud protection
[Often times] collision insurance that gives the rental car company a layer of protection against damage done to the rental car while in the renter's possession

### BRIEF DESCRIPTION OF THE DRAWINGS

FIG. 1 is an example of a detailed rate breakdown for members and dealers in a car rental embodiment.

FIG. 2 illustrates the relationship between the membership company (also referred to as the trusted third party), the affiliate rental car company (also referred to as the provider), and the card holder rental car customer (also referred to as the end user);

FIG. 3 illustrates projected revenue growth of debit-card providers;

FIG. 4 is a graph illustrating the revenue growth of FIG. 3 graphically;

FIGS. 5, 6, and 7 illustrate projected revenue of the rental car industry;

FIG. 8 illustrates income levels of debit-card consumers;

FIG. 9 illustrates statistics related to the number of car rental companies in the united States;

FIGS. 10 and 11 illustrate marketing methods and target markets for the present invention;

FIGS. 12 and 13 illustrate examples of dealer and member acquisition schedules, respectively; and

FIG. 14 illustrates basic elements used to enable the invention.

### DETAILED DESCRIPTION OF THE INVENTION

More consumers are shifting away from using credit cards due to the expense of owning a card as well as steep interest charges on any balance. These consumers are turning to debit cards as they are easy to use, payment is handled immediately and there are no interest charges or billing issues.

Unfortunately, when a potential rental customer attempts to use a debit card, most rental car companies reject that rental as a debit card does not carry the above benefits to the rental car company. Additionally the extra time needed to qualify a customer slows down the rental process. Thus, ZARR Card Rental was created to fill the void left by a lack of these features on a debit card.

The product offering will begin by enrolling of affiliate locations that will have access to the ZARR website to facilitate the membership of individual renters to take advantage of the card and its features.

In addition, an aggressive marketing program will reach out to potential rental car customers in the affiliate's area of influence.

On a national level the program will be exposed to franchisors who have 100 to 200 independently owned rental locations around the country. Additionally ZARR will offer the program to airport operators on a national level as most of these locations are corporate owned.

By enrolling individuals in its membership program, ZARR enables non-credit card holders and individuals who dislike using credit cards, the ability to rent vehicles from traditional car rental dealers and pay via a ZARR authorized membership card.

ZARR generates revenue through the following:
1. Members
   a. Membership card sales
   b. Monthly or annual membership fees
   c. Reservation fees
2. Dealers
   a. Rental Fees
   b. Insurance
3. Payment Processing Companies
   a. Share of profits on processing debit card transactions
   b. Share of profits on processing checks
   c. Share of profits on processing transactions on Membership cards

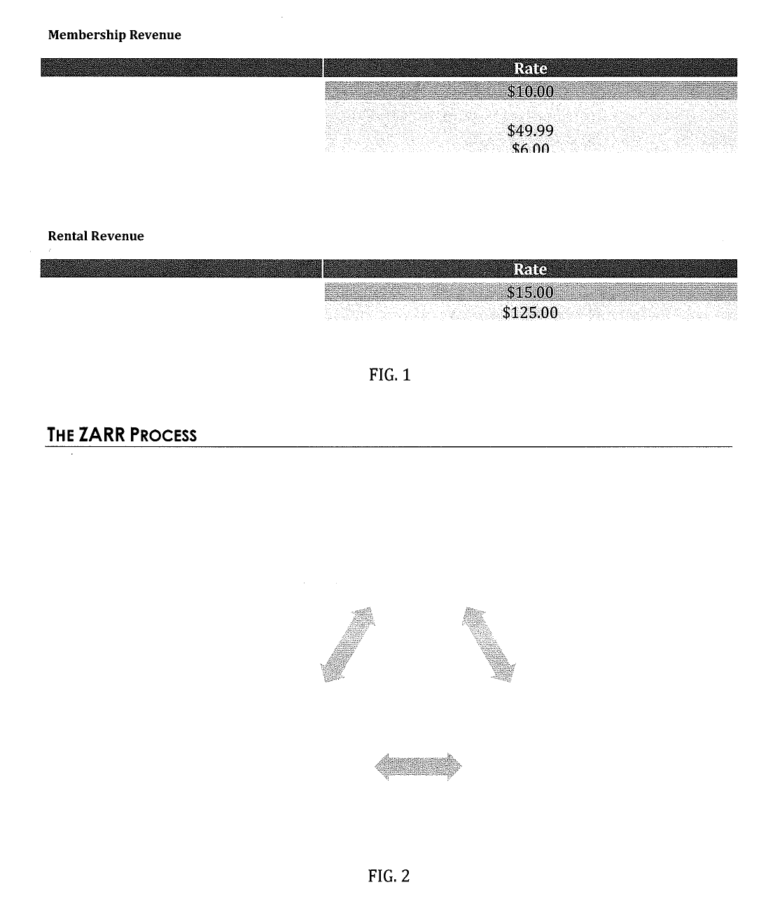

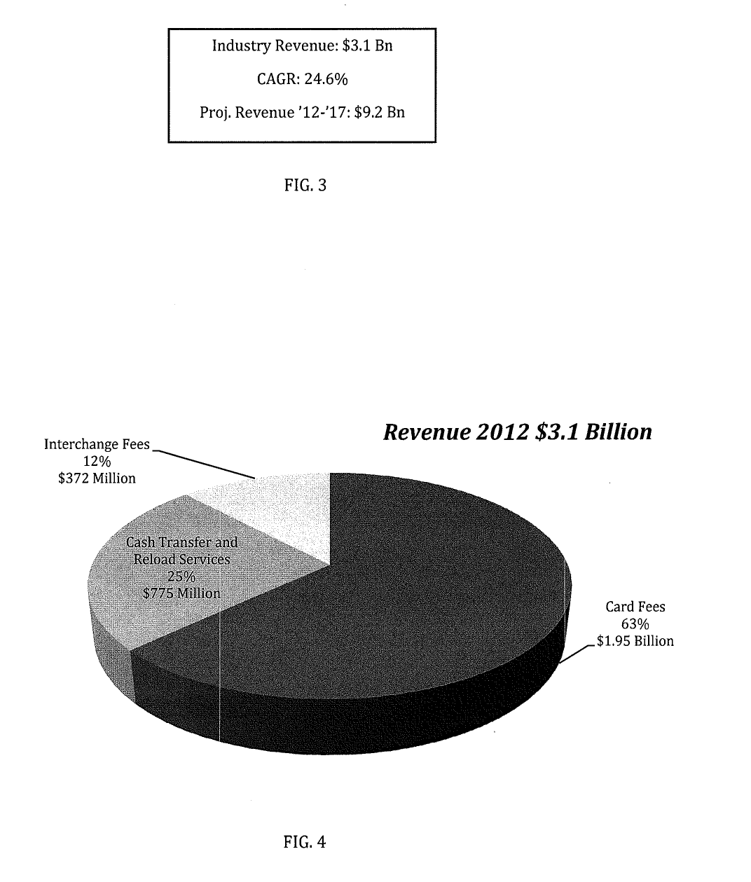

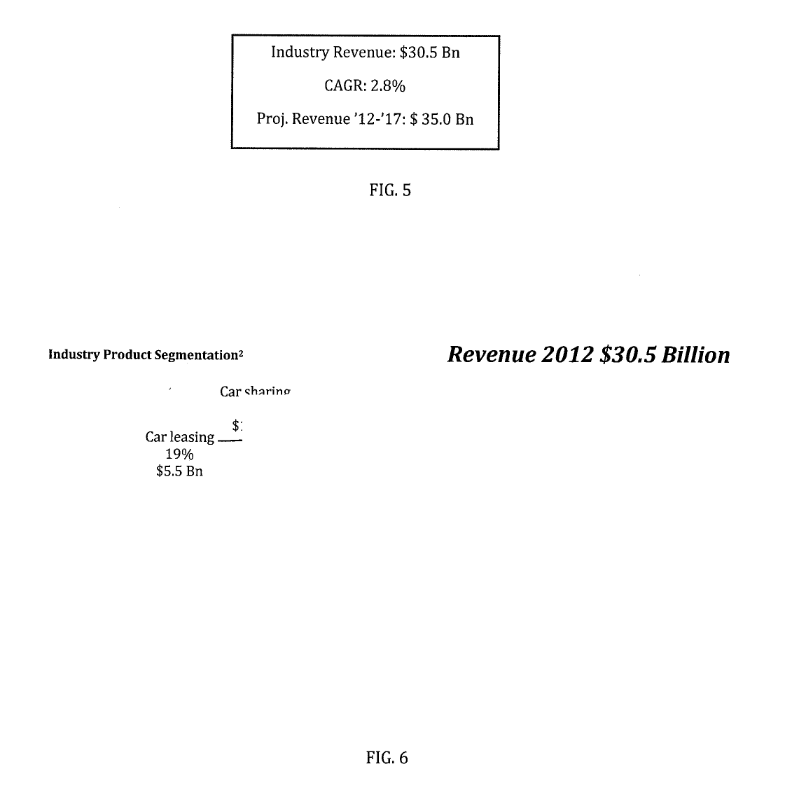

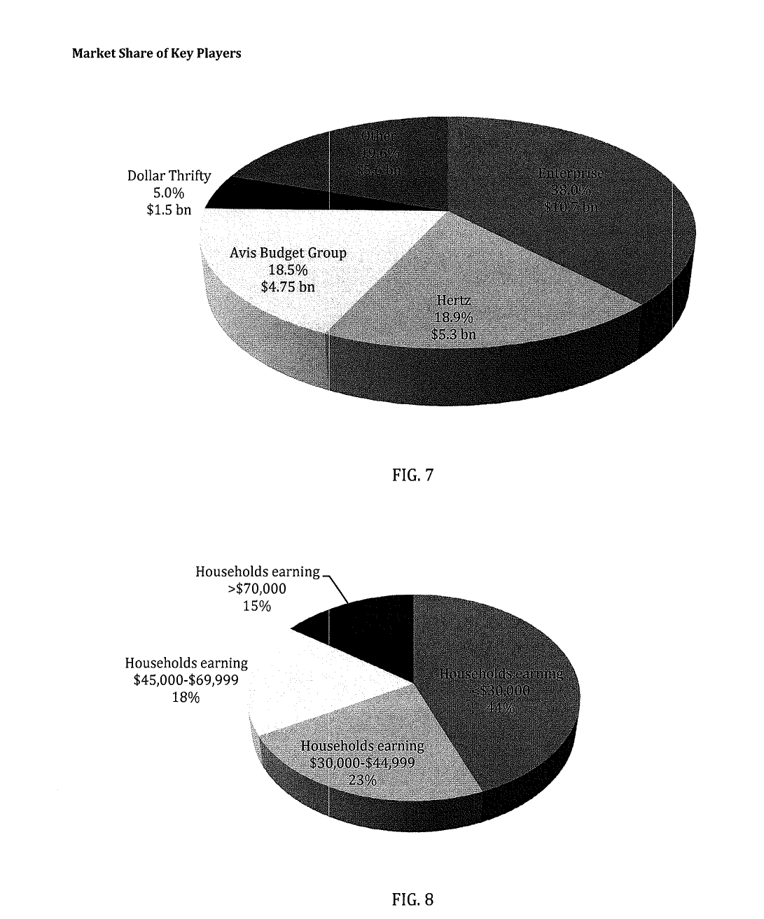

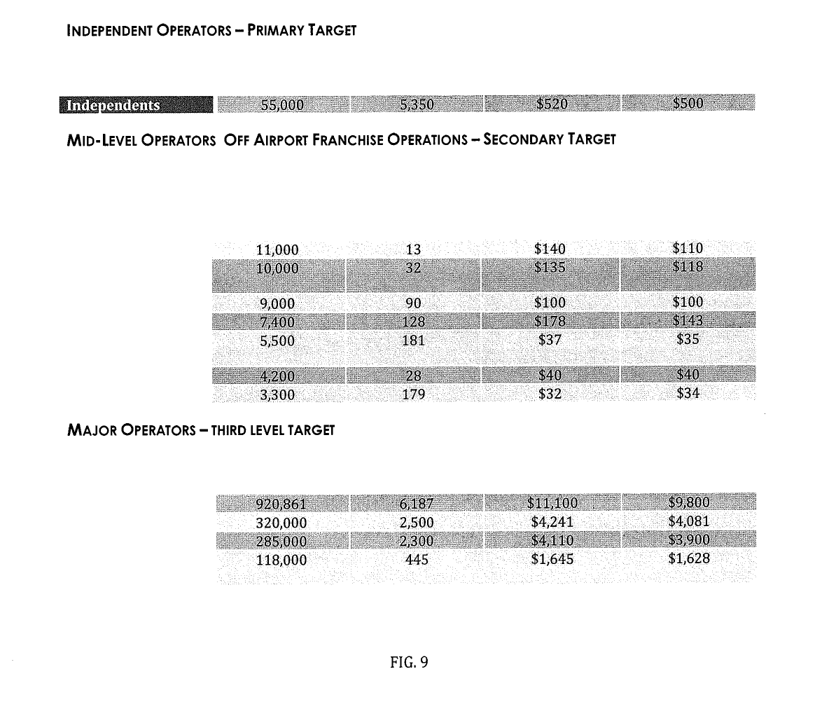

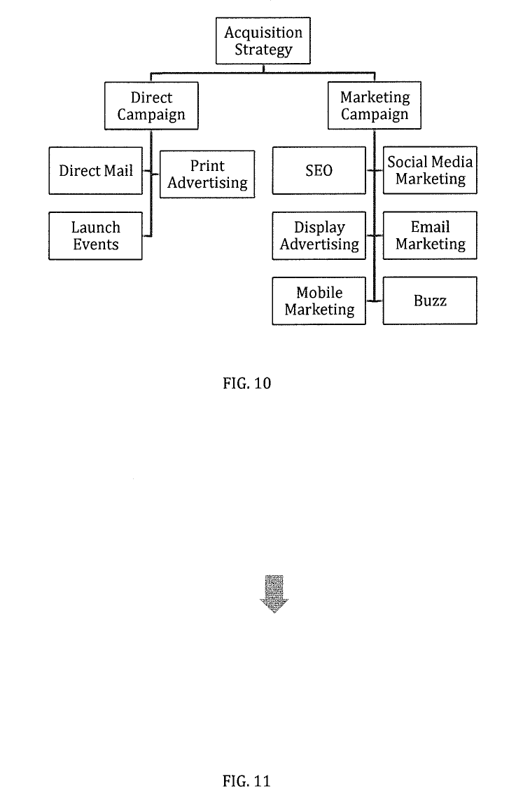

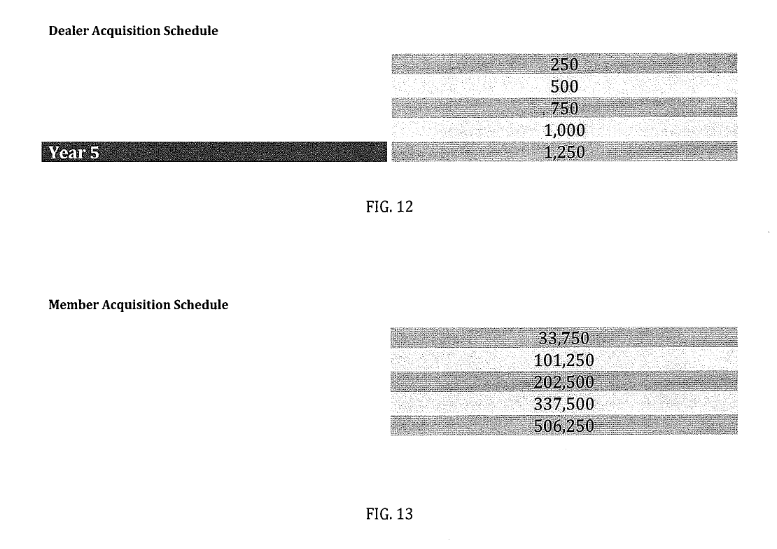

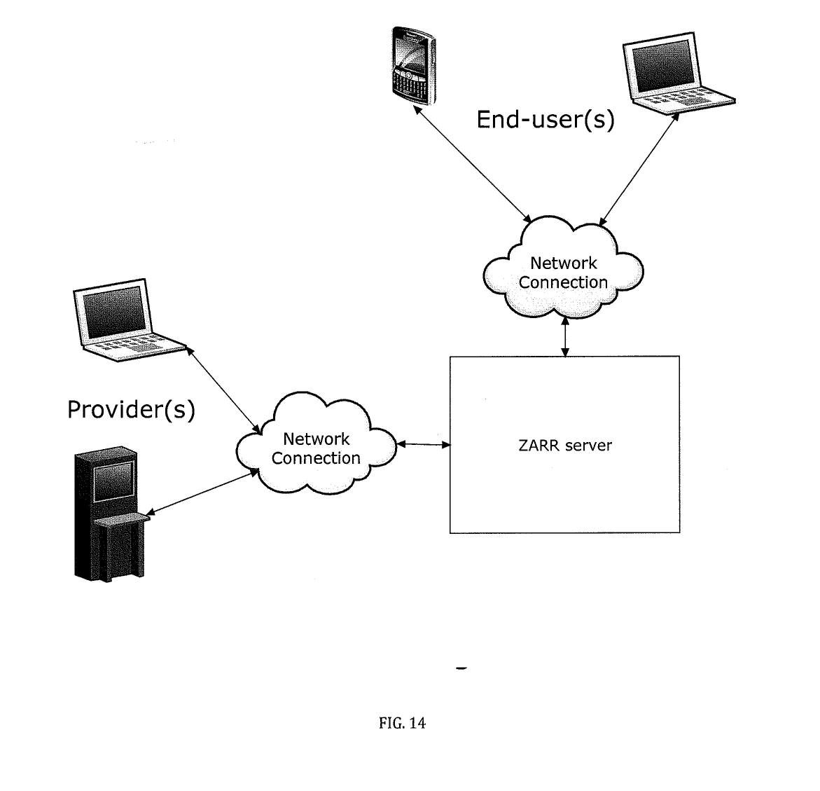

An example of a detailed rate breakdown for members and dealers are highlighted in FIG. 1.

Direct costs originate from implementation of targeted Point of Sales, marketing and advertising costs.

When a potential end-user applies for the membership card, ZARR will undertake an initial qualification of the end-user based on existing rental industry standards. ZARR will also use an innovative fraud protection portal, described in more detail below, to qualify the end-user and check the end-users' age, Social Security Number, address, previous addresses as well as other information.

As soon as an end-user is qualified, they will be able to pre-load the card with funds through the ZARR website for use at participating locations. A $75.00 minimum balance will be retained on their account for subsequent charges after the rental for items such as fuel or parking tickets.

When a end-user uses a ZARR Card, the following will happen:
The end-user will have collision insurance during the term of the rental
Provider agents will input the card number and ZARR's software will instantly RE-QUALIFY the end-user in case anything has changed
Provider agents will be able to print out qualification information from the ZARR site
The ZARR website will be accessed to ensure that funds are available

The uniqueness of the ZARR Card is the ability of end-users and providers (e.g., rental car companies) to bridge the gap left by the lack of a credit card and its associated role as a credit check and insurance provider.

It is a cost effective way for the end-user to be instantly approved to rent a car. Additionally the provider has an opportunity to secure a rental transaction that otherwise would have been declined.

Due to a fraud check being conducted for every transaction, the protection provided to providers by ZARR far exceeds that of a traditional credit card.

ZARR Card operates within the prepaid credit and debit card providers industry. This industry includes companies that issue pre-loaded open-loop credit and debit cards to consumers for making purchasers. Over the past five years to 2012, debit card providers experienced explosive growth. While other industries were crippled by the recession, the weak economy played to the industry's strength; fewer consumers had access to credit and/or bank accounts and opted instead for prepaid cards. In 2012 industry revenue is expected to grow by 33.3% to reach $3.1 billion.

In the five years to 2017, industry revenue is projected to grow at a Compound Average Growth Rate (CAGR) of 24.6% to reach $9.2 billion. Industry operators primarily generate revenue from card fees, cash transfers, reload services and interchange fees. According to Nerd Wallet's 2012 survey of 40 popular prepaid debit brands, an average card costs nearly $300 per year in basic fees. These fees do not include activation, cancelation, paper statement and other fees. The study also noted that the single greatest charge is usually the monthly fee, which topped out at $14.95 per month. The pie chart below illustrates the breakdown of the industry's products and services segmentation.

ZARR Card Rental operates in parallel with the car rental industry. Companies in this industry rent or lease automobiles to customers. Within the industry air travelers are their primary market due to the large portion of rental cars picked up after flights, and at airport locations. However, many operators have continued to expand into off-airport markets to reduce their dependence on air travel. For instance, Hertz, Avis and Budget have increased their involvement in the insurance replacement market. This sub-segment provides replacement vehicles for individuals whose car is under maintenance or in the repair shop and is paid for by the consumer's auto insurance.

Industry revenue grew 6.6% in 2011 to reach $28.8 billion. Revenue is expected to grow an additional 5.5% to $30.5 billion in 2012. By 2017, industry revenue is forecasted to reach $35.0 billion representing a 2.8% average annual growth rate due to the strengthening of key external factors, which include the increasing number of air travelers, per capita income growth and corporate profitability.

Leisure car rentals have made up the largest portion of industry revenue over the last few years, largely in response to the sizeable drop in business travel as a result of the economic downturn. Car sharing has also grown in popularity over the past five years as major players enter more markets across the country as awareness of the availability of car sharing increases (Zip Car). The industry includes a small car-leasing segment, which does not include cars leased to own. Car leasing involves paying an up-front fee plus fixed monthly payments in return for taking possession of, and operating the car for 12 months or more.

The largest industry operator is Enterprise Rent-A Car with a 38% share of the market. The company owns approximately 7,600 neighborhood and airport locations and operates the world's largest rental fleet with more than 1.1 million vehicles. In 2007 the company acquired Vanguard Car Rental Group which gave Enterprise the Alamo and National car rental brands. The company offers business and leisure rentals and has a “month by month” rental program. In addition, Enterprise expanded into car sharing in 2008 with its WeCar program.

With 18.9% share of the market, Hertz represents the second largest industry operator. The company provides car, truck and van rentals, car leasing, heavy equipment rental and limited used cars and heavy equipment sales. Hertz has expanded into car sharing in 2008 through its Connect program, which now operates as Hertz on Demand. The company partners with airlines and hotels to offer discounts, reward miles and other incentives to car rental customers who book with the company's strategic partners.

Avis, Budget Group is third with an 18.5% market share. Avis, Budget consists of two brands: Avis and Budget Rent a Car. Avis concentrates on business travelers and premium leisure travelers. Budget targets price-conscious travelers. At the beginning of 2011 there were 1,250 Avis locations and 850 Budget locations globally. Avis, Budget Group offers a “mini lease” program in which the car can be rented for 60 days to 11 months.

In 2009, there were 183 million people with debit cards, roughly 60% of the entire U.S. population¹ ¹ U.S. Census

As of 2010, there were over 82.6 million licensed drivers without cars.

Since the target market will primarily consist of debit card holders it is important to analyze the credit and prepaid debit card industry. The industry appeals to consumers who generally have few banking options, the largest users tend to be lower-income adults and younger individuals. More than 85% of prepaid card users have less than $70,000 in annual household income.

In terms of age breakdown, approximately 43% of all prepaid cardholders are members of Generation Y.

Prepaid debit cards have increasingly become an attractive alternative to traditional bank accounts for certain segments of the population, i.e. people without a checking or savings account.

In addition to economic shifts and size of the younger population driving demand, the advent of online shopping is a major driving force for this industry. Industry services are helpful for who do not have conventional credit cards and those who are fearful of using credit or debit cards on the internet due to security and privacy concerns.

In 2010, the U.S. population was approximately 309 million people, of which 210 million were licensed drivers. During the same time period there were 242 million vehicles in the country with each household owning close to 2 vehicles on average.

It is estimated that there were over 82.6 million licensed drivers without cars in the U.S. in 2010.

This population represents one of the key target markets for ZARR.

In addition to car renters, rental car companies are a secondary target market as they are the providers of vehicles for ZARR members.

The following highlights the number of rental locations across the U.S. divided in primary, secondary and tertiary tiers.

ZARR Card will transform the rental car market by becoming the smart alternative to debit and credit cards. By taking the best of both products and adding increased benefits such as car insurance coverage and qualification checks at the beginning of each rental, ZARR will change the auto rental industry.

The fact the card is made for a specific purchase and can only be used at participating affiliates creates additional security for a rental car company. Collision insurance on the card protects the renter and auto rental company in the event of any damage to the car.

There will be additional avenues for further use of the card that will be provided in the future, e.g. International travelers will be able to purchase the card online before arriving in the US, thereby providing additional security as they travel.

American Express Car Rental Insurance (Policy AX0126, or Policy AECRI-IND) are underwritten by AMEX Assurance Company, Administrative Office, in Phoenix, Ariz. Coverage is determined by the terms, conditions, and exclusions of the respective policies (see above) and is subject to change with notice.

Visa is a global payments technology company that enables consumers, businesses, financial institutions and governments to use digital currency instead of cash and checks. Visa Standard Credit, Visa Rewards Credit and Visa Premium Rewards cardholders receive Auto Rental Collision Damage Waiver coverage for damage due to collision or theft. To activate this coverage, a customer completes the entire rental transaction with an eligible Visa card and declines the collision damage waiver (CDW) if offered by the rental company.

MasterCard cardholders benefit from the company's MasterRental coverage. In order to receive coverage the cardholder must initiate and pay for the entire rental agreement/contract with an eligible MasterCard. Cardholders must decline the collision damage waiver and rent the vehicle in their own name and sign the vehicle rental agreement/contract. Rental periods cannot be longer than 15 days and the vehicle must have a MSRP below $50,000 in order to receive coverage.

Discover offers cash back, miles and student cards. All Discover Card's come with a Car Rental Insurance Plan that provides $25,000 of secondary collision damage insurance when a cardholder uses their Discover Card for the rental transaction and the cardholder declines coverage offered by the rental agency.

The Zarr Card system provides consumers with added flexibility and choices. It is the only prepaid card service focusing on rental car industry. The program is designed so that it can be used in and expanded to other markets that require credit cards for purchases.

As a membership company, ZARR targets people from all backgrounds, particularly debit card holders who require car rentals. By effectively exploiting an untapped target market, ZARR helps both parties by enabling people who would otherwise need to go through bothersome methods to secure a car rental, while allowing rental companies to securely expand into a larger market.

In order to effectively capture the target market, ZARR intends on engaging a seasoned marketing agency to assist in formulating and implementing various marketing campaigns, both traditional and online.

ZARR will align itself with the interests of its target market by partnering with various organizations and businesses, including those shown in FIG. 11.

Partnerships with car rental shops are crucial to success. The more providers participating in the network the greater the volume of transactions.

In the future, ZARR plans to add more benefits for its members and will explore partnerships with various auto-related providers and others.

By creating strategic partnerships, ZARR will create brand awareness and generate more memberships.

Point of sale Displays, Brochures, Rental Jackets, Window Slicks and Posters will be provided to all affiliates.

ZARR will supply a dedicated computer kiosk in each location to assist in acquiring new cardholders. Benefits include;
Reduced involvement by Affiliate staff to enroll members; instead activities will be focused on selling a membership card and compiling the rental documentation
Instant approval of members
Continuous display advertising of the program at each rental location

The Company will explore implementation of an aggressive SEM and SEO strategy to attract members via keyword optimization, reviews, published articles and blogs.

Revenue will be primarily driven by membership fees, rental company fees and processing rebates. In the future, the Company intends on working with rental companies to generate income through car financing.

ZARR Card will generate revenue from rental car companies through a flat rate rental fee for each rental derived from the program in addition to a monthly program fee.

Membership fees include a one-time set up fee, annual and/or monthly payments depending on the membership type and rental reservation fees.

In terms of processing, the Company generates revenue through:
a. Share of profit from credit card processing revenue from dealers
b. Share of profit from ZARR Card profits via dealers
c. Rebate of costs charged to ZARR for online processing

FIG. 14 is a basic block diagram showing a system for implementing the method of the invention.

In FIG. 14, illustrated are the basic elements used to enable the invention. The Zarr server is a central point accessed by both providers and end-users. It includes processors, web-hosting servers, and data storage (or access to same) needed to facilitate the operations of the invention. The processors are configured, in a well-known manner, to provide reservations systems, account management, web access and graphical user interfaces, receive funds, send out notification, and any other processing element of the inventive system and method. The Zarr server itself is configurable by the membership company to provide these services and functionality, and although not shown in FIG. 1, it is understood that the membership company can input, store, modify, display and process information on the Zarr server. Training on use of the system can be provided in person, online, or both.

Providers access the Zarr server via a network connection such as the Internet. This access can be implemented via processing devices of any known kind, for example, desktop computers, laptop computers, handheld devices such as smart phones and mobile phones, a kiosk that includes an input device and a display device; essentially any known processing device that enables information to be input to the server and displayed to a user of the processing device can be utilized.

End-users also access the Zarr server via a network connection such as the Internet. This access can also be implemented via processing devices of any known kind, for example, desktop computers, laptop computers, handheld devices such as smart phones and mobile phones, a kiosk that includes an input device and a display device; essentially any known processing device that enables information to be input to the server and displayed to a user of the processing device can be utilized.

In use, a provider (e.g., a car rental company) accesses the Zarr (trusted third party) server via a “Potential affiliate” (provider) portal, where information is gathered and stored about the potential new provider. If approved to become a provider, the provider is given access to a second portal of the server (an approved provider portal), access to which is limited to new, approved providers. Here, the approved provider can manage their account, view information about end-users (card-members) who are enrolled in the program, receive reservation requests from the Zarr server, accept the reservations, and all other aspects of the transaction being “brokered” by the membership company running the Zarr server.

Similarly, a potential end-user (e.g., a potential Zarr card member who wishes to be able to rent a car without having a credit card) can access the server via a potential new end-user portal, which solicits the information needed to approve (or disapprove) them as a Zarr card member. This access can be made directly by the potential new card member (i.e., via their smartphone, computer, etc) or it could be done with assistance (e.g., at the location of an approved provider, who can allow the potential new card member to access the potential new end-user portal via an onsite kiosk, an onsite computer, or even by taking information from the potential new card member and inputting it to the potential new end-user portal on their behalf). Regardless of how the person access the potential new end-user portal, information is solicited (an application is filled out) that will enable the membership company to approve or disapprove the potential new card member (end user). Among other aspects of the approval process, the application is forwarded or otherwise provided to a verification company (for example, Electronic Verification Systems) to have a fraud check conducted in a well-known manner. This process is very quick (essentially instantaneous). Once approved, the new Zarr card member (end user) is given access to a portal (approved end-user portal) accessible only to approved end users. A card (transaction element) is issued and the car member (end user) is free to access the system.

The approved new end-user is given access to the approved end user portal, which allows the member to manage their account—add funds, make a reservation, set preferences, search for locations that accept the Zarr card, etc. In addition, whenever a transaction is attempted by the car member, a fraud check can again be conducted each time, to essentially update the fraud check. Further, the system checks to make sure funds are available for the proposed transaction, and if the funds are insufficient, attempts can be made to remedy this, and if it can't be remedied, then the transaction can be disapproved.

The insurance aspect of the system of the present invention is managed by the membership company. In a preferred embodiment, the membership company establishes a relationship with an insurance vendor, who provides typical levels of insurance for the end users.

As noted above, the invention is described in this example as being implemented in a rental car scenario. However, this is given for purpose of example only, and other implementations, including sale of airline seats/tickets, sale of goods, sale of hotel stays, or any other transaction where the purveyor might otherwise require a credit card to complete the transaction, fall within the scope of this disclosure and are considered to be included as part of the inventive concepts described herein.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

While there has been described herein the principles of the invention, it is to be understood by those skilled in the art that this description is made only by way of example and not as a limitation to the scope of the invention. Accordingly, it is intended by the appended claims, to cover all modifications of the invention which fall within the true spirit and scope of the invention.

1. A method for providing credit-card-free access to an end-user who is renting an item from a provider, comprising:
registering an end-user with a trusted third party via a trusted-third-party server using an end-user portal;
registering a provider with the trusted third party via the trusted-third-party server using a provider portal; and
providing the end user with a transaction element usable in connection with said trusted third-party server, said transaction element configured to provide to the provider, via the trusted-third-party server:
verification of the identity the end user;
verification of funds available to rent an item for the provider; and
a transaction fraud check to confirm, at the time of a transaction, that the end-user is authorized to conduct the transaction.

2. The method of claim 1, wherein the registration of the end-user with the trusted third party comprises the end user completing an application for forwarding to a verification company, said verification company using the completed application to conduct an initial fraud check on the end-user and providing results of said initial fraud check to said trusted-third-party server, where it is stored.

3. The method of claim 2, wherein the trusted-third-party manages the providing of insurance to the end user by establishing a relationship with an insurance provider, which insurance provider provides insurance to the end user.

4. The method of claim 3, wherein the end-user portal is accessible via an end-user device capable of connecting to the trusted-third-party server.

5. The method of claim 3, wherein the end-user portal is accessible via a device provided at a location of the provider.

6. The method of claim 3, further comprising:
providing an authorized end-user access to an authorized end-user portal providing the end-user with account management capability so that the end-user can manage account information stored on said trusted-third-party server.

7. The method of claim 3, wherein the item to be rented is a rental vehicle.

8. The method of claim 7, wherein the provider comprises a vehicle-rental company.
